(19) United States
(12) Patent Application Publication
(10) Pub. No.: US 2021/0104169 A1
(43) Pub. Date: Apr. 8, 2021

(54) SYSTEM AND METHOD FOR AI BASED SKILL LEARNING

(71) Applicant: DMAI, Inc., Los Angeles, CA (US)

(72) Inventor: Wei Si, Chino Hills, CA (US)

(21) Appl. No.: 17/064,682

(22) Filed: Oct. 7, 2020

Related U.S. Application Data
(60) Provisional application No. 62/911,572, filed on Oct. 7, 2019.

(51) Int. Cl. G09B 5/06; G10L 25/51; G06T 13/00; G06T 11/00; G10H 1/00; G09B 19/00; G06N 20/00

(52) U.S. Cl. CPC G09B 5/065; G10L 25/51; G06T 13/00; G06T 11/00; G09B 15/00; G09B 19/003; G06N 20/00; G10H 2210/091; G10H 1/0008

(57) ABSTRACT

The present teaching relates to method, system, medium, and implementations for facilitating skill learning. Multimedia data in different modalities are received, wherein such data are recorded based on a performance exhibiting a skill. The data in each of the modalities are analyzed to extract information exhibited in the performance that is relevant to the skill and is used to generate an animated tutoring script. Such generated animated tutoring script is then archived for future access to enable a skill learning session in an augmented reality.

### CROSS-REFERENCE TO RELATED APPLICATIONS

The present application claims priority to U.S. Provisional Application No: 62/911,572, filed Oc. 7, 2019, which is hereby incorporated by reference in its entirety.

### BACKGROUND

### 1. Technical Field

The present teaching generally relates to computer. More specifically, the present teaching relates to augmented reality.

### 2. Technical Background

In our society, most learning is via teaching/tutoring or self-learning. This includes learning academic concepts or acquiring skills in different fields such as skills of playing certain music instruments, skills of operating industrial equipment, or skills of assembling physical things. With the advancement of computers and ubiquitous network connections, in recent years, more and more teaching/tutoring may be conducted in a remote manner with a teacher or tutor at one location providing lectures to a student who resides at a remote location and receives training via network connections.

Although such advancement enables teacher/student pairing more easily without too much concern about the physical separation, there are various shortcomings associated with such schemes. For example, although a teacher may lecture to a remote location, it is not easy to do so based on learner's performance during the session. This is especially so in certain types of skill learning such as music instrument playing. Depending on how the setup is, the teacher may not be able to see what a student did. Although the teacher may listen to the music played by a student and guess what may not be adequate or correct, the effect is not the same as the teaching sitting next to the student, observing the action and correcting as needed. In addition, in a remote setting, a teacher usually has to verbally lecture without being able to physically demonstrate or illustrate what is the correct action to a remotely located student. This is especially problematic when it involves skill learning of physical activities, including learning to play music instruments or assembling things.

The traditional remote learning does not allow people who desire to learn some skills by taking advantage of the vastly available resources on the Internet. In a traditional setting, in order to receive tutoring, such a person needs to find a teacher who mutually agrees to tutor via remote teaching means, while with various types of data vastly available on the Internet, a person can find any media data such as videos that are created to demonstrate certain skills to a viewer. For example, for piano playing, there are many videos available on the Internet that show different performers wire connection of some devices, etc. Although a person can attempt to learn a skill by viewing such data, it is not easy to master a skill based on such data without more.

Thus, there is a need for methods and systems that address such limitations.

### SUMMARY

The teachings disclosed herein relate to methods, systems, and programming for data processing. More particularly, the present teaching relates to methods, systems, and programming related to modeling a scene to generate scene modeling information and utilization thereof.

In one example, a method, implemented on a machine having at least one processor, storage, and a communication platform capable of connecting to a network for facilitating skill learning. Multimedia data in different modalities are received, wherein such data are recorded based on a performance exhibiting a skill. The data in each of the modalities are analyzed to extract information exhibited in the performance that is relevant to the skill and is used to generate an animated tutoring script. Such generated animated tutoring script is then archived for future access to enable a skill learning session in an augmented reality.

In a different example, the present teaching discloses a system for facilitating skill learning. The system includes a multimedia data preprocessor and an animated tutoring script integrator. The multimedia data preprocessor is configured for receiving multimedia data in different modalities recorded based on a performance exhibiting a skill and analyzing data in each of the modalities to extract information relevant to the skill exhibited in the performance. The animated tutoring script integrator is configured for integrating a tutoring script generated based on the skill and multimedia features synchronized with the tutoring script in each of the modalities relevant to the skill to generate an animated tutoring script. The animated tutoring script is then archived for future access to enable a skill learning session in an augmented reality.

Other concepts relate to software for implementing the present teaching. A software product, in accord with this concept, includes at least one machine-readable non-transitory medium and information carried by the medium. The information carried by the medium may be executable program code data, parameters in association with the executable program code, and/or information related to a user, a request, content, or other additional information.

In one example, a machine-readable, non-transitory and tangible medium having data recorded thereon for facilitating skill learning, wherein the medium, when read by the machine, causes the machine to perform a series of steps. Multimedia data in different modalities are received, wherein such data are recorded based on a performance exhibiting a skill. The data in each of the modalities are analyzed to extract information exhibited in the performance that is relevant to the skill and is used to generate an animated tutoring script. Such generated animated tutoring script is then archived for future access to enable a skill learning session in an augmented reality.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The present application contains at least one drawing executed in color. Copies of this patent or patent application publication with color drawing(s) will be provided by the Office upon request and payment of the necessary fee.

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates exemplary topics related to skill learning;

FIGS. 1B-1D visualize exemplary types of skills that may be acquired via skill learning;

FIG. 2A depicts an exemplary setting for artificial intelligence (AI) based skill learning, in accordance with an embodiment of the present teaching;

FIG. 2B depicts a different exemplary setting for AI based skill learning, in accordance with a different embodiment of the present teaching;

FIG. 3 depicts an exemplary networked environment in which information available from different sources is used to generate animated tutoring scripts for skill learning, in accordance with an embodiment of the present teaching;

FIG. 4A is a flowchart of an exemplary process of creating animated tutoring scripts, in accordance with an embodiment of the present teaching;

FIG. 4B is a flowchart of an exemplary process of AI based skill learning in a dynamic scene using an animated tutoring script, in accordance with an embodiment of the present teaching;

FIG. 4C shows an exemplary representation of a portion of an animated tutoring script, in accordance with an embodiment of the present teaching;

FIG. 5 depicts an exemplary high level system diagram of an animated tutoring script generator, in accordance with an embodiment of the present teaching;

FIG. 6 is a flowchart of an exemplary process of an animated tutoring script generator, in accordance with an embodiment of the present teaching;

FIG. 7 depicts an exemplary high level system diagram of an AI based skill learning system, in accordance with an embodiment of the present teaching;

FIG. 8A is a flowchart of an exemplary process of an AI based skill learning system for conducting skill tutoring in a dynamic scene based on an animated tutoring script, in accordance with an embodiment of the present teaching;

FIG. 8B is a flowchart of an exemplary process of an AI based skill learning system for adaptively tutoring a skill based on an animated tutoring script and dynamic observations, in accordance with an embodiment of the present teaching;

FIG. 9 is an illustrative diagram of an exemplary mobile device architecture that may be used to realize a specialized system implementing the present teaching in accordance with various embodiments; and

FIG. 10 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching aims to address the deficiencies of the traditional skill learning approaches and to provide methods and systems that enable more effective skill learning based on AI technologies. Specifically, the present teaching may access available data (such as video), perform AI based multimedia analysis to identify information relevant to an underlying skill, generate animated scripts across different media that incorporates synchronized tutoring components to be utilized to tutor a person the skill. Such generated animated tutoring scripts may be used by an AI based skill learning system running on a device (e.g., a smart phone, Smart glasses, or other wearables) to conduct a tutoring session in an augment reality scenario, e.g., by projecting visual instructions (put which fingers on which keys) on object (e.g., a piano) on a dynamically observed scene and/or providing acoustic instructions synchronized with the visual instruction in accordance with the content of the animated tutoring script. Thus, the delivery of the tutoring or facilitating a person to learn a skill is adaptively accomplished based on the observed scene.

The AI based skill learning system incorporates the camera and corresponding processing functionalities to enable the observations of not only the dynamic scene a user is in so that the tutoring instructions can be projected to the correct locations in the scene but also the observations of the performance of the user so that the tutoring session may be adaptively controlled based on the performance. The present teaching allows a much wider range of materials or information, whether it is intended for teaching or tutoring or not, to be used to enable skill learning by anyone who is interested. For example, if videos of different pieces of music performed by a famous pianist are available on the Internet, the present teaching may be utilized to analyze the videos and devise, for each of them, an animated tutoring script which can be used to assist anyone who desires to learn the skill of the pianist on this piece of music. In using an animated tutoring script to facilitate a user to learn a relevant skill, an AI based skill learning system, according to the present teaching, may not only provide AI based tutoring in an augmented reality scenario but also be configured to observe the user's performance in the learning session in order to adaptively adjust the AI based tutoring.

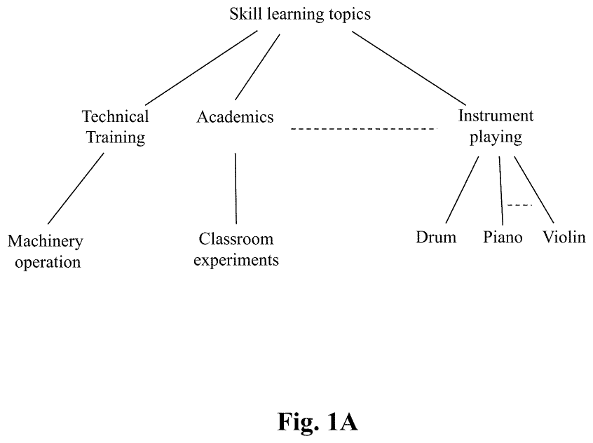

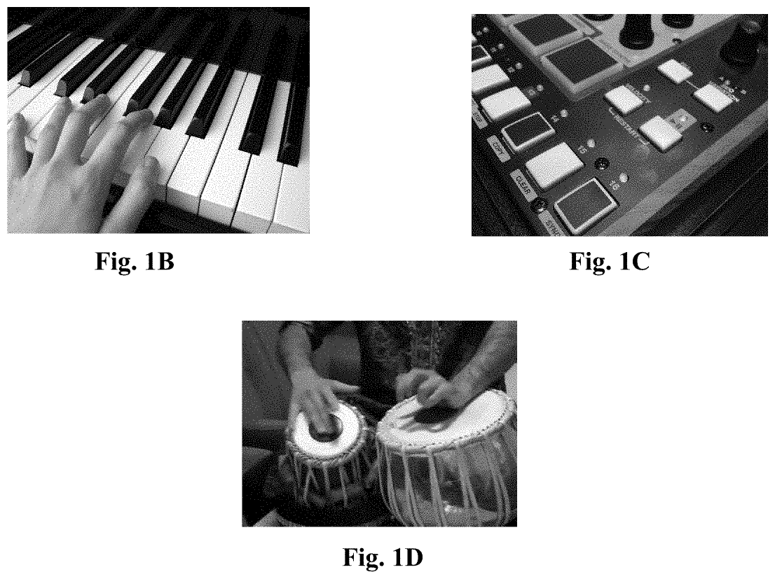

FIG. 1A illustrates exemplary topics related to skill learning. Skill learning can be applied in almost all fields and what are shown in FIG. 1A are merely for illustration purposes. For example, one can learn relevant skills in different technical domains, such as how to operate certain machineries, in academics such as how to do certain experiments, . . . , and/or in playing music instrument such as drums, piano, . . . , violin, etc. FIGS. 1B-1D visualize exemplary types of skills that may be acquired in different fields via skill learning. For instance, FIG. 1B shows that skill in playing piano involves correct finger positions and how fingers should transition from one part to an adjacent piece of music, etc. FIG. 1C shows an exemplary operation interface of an equipment with buttons/switches, e.g., to operate the equipment, one has to learn the skill of manipulating the buttons/switches at appropriate times. FIG. 1D shows drum playing where skills need to be learned as to when different fingers of different hands hit which areas of which drum.

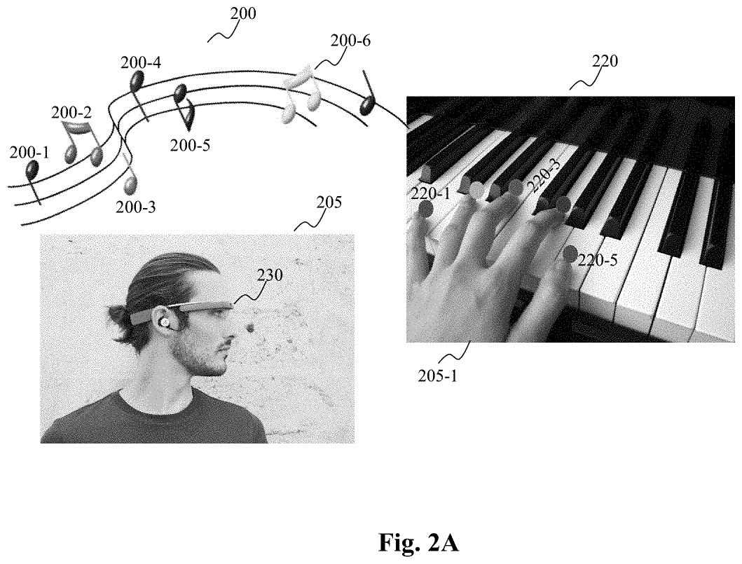

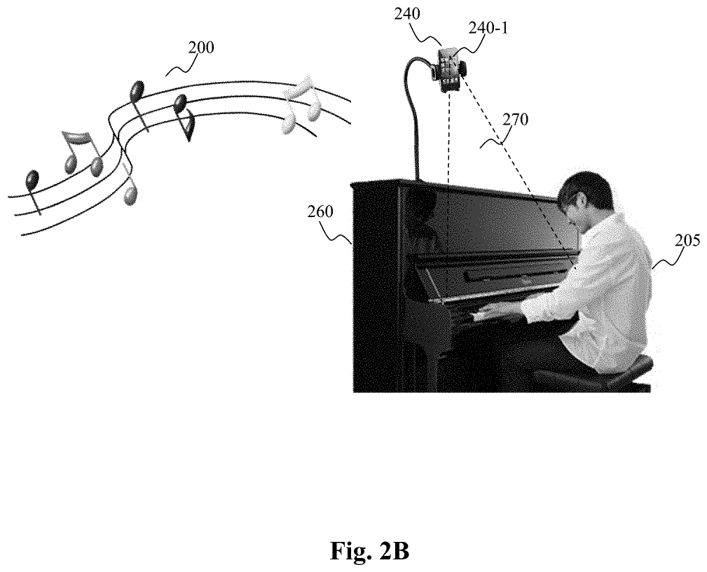

FIG. 2A depicts an exemplary setting for artificial intelligence (AI) based skill learning of piano playing skills, in accordance with an embodiment of the present teaching. As shown, when a learner 205 sitting in front of a piano 220 and places his hands 205-1 on the piano to learn how to play a specific piece of music 200 with music notes 200-1, 200-2, 200-3, 200-4, 200-5, 200-6 . . . , a wearable device 230 with an embedded camera implementing the present teaching may observe the dynamic scene surrounding the hands on the piano and project visual instructions (220-1, . . . , 220-3, . . . , 220-5) and/or oral instructions (not shown) to the learner in accordance with an animated tutoring script generated based on another skilled player playing the music piece 200. For instance, according to the animated script, when a learner is playing the portion of the music piece 200 involving music notes 200-1, 200-2, 200-3, 200-4, 200-5, 200-6, . . . , the fingers of a player should position on corresponding keys 220-1 (corresponding to the purple music note 200-1), 220-2 (corresponding to the green music note 200-2), 220-3 (corresponding to the blue music note 200-3), 220-4 (corresponding to the red music note 200-4), and 220-5 (corresponding to the purple music note 200-5). With that understanding and with the visual observation of the piano, the AI based skill learning system projects visual instruction on respective keys. In some embodiments, the AI based skill learning system may also visualize a virtual hand with finger positions placed on the correct keys (now shown). In this manner, the skill learner may simply follow the projected visual instructions and learn how to play. Of course, such visual instructions are dynamic, i.e., the fingers move along with the music and the skill learner may follow up with the instruction my moving hands accordingly.

In some embodiments, the skill learner may be able to communicate with the AI based skill learning system to adjust the learning parameters, e.g., adjust the speed of the playing at different stages of the learning, turn on/off of the music player from the player's performance (based on which the animated tutoring script is derived), or invoke oral instructions if available. In this manner, the skill learner may dynamically adjust the way to learn the skill in a manner that is appropriate. For example, if a skill learner is initially unfamiliar with the piece of music, the speed of tutoring by the AI based skill learning may be much slower than the actual speed of the player's performance. When the skill learner is becoming better, the speed of tutoring the playing by the AI based skill learning system can increase accordingly until the skill learner substantially master the skill developed for the piece.

In some embodiments, each animated tutoring script may include various meta information, e.g., indicating the underlying piece of music, the composer, the player, the level of proficiency of a skill learner needed to learn how to play this particular piece of music from this particular player. Such information may be used to guide a skill learner to choose appropriate animated tutoring scripts for skill learning at appropriate existing level of skills. Such meta information may also allow a skill learner to choose any player and any preferred piece of music for his/her skill learning.

In some embodiments, an animated tutoring script may also incorporate oral instructions to be used in connection with certain selected learning mode. For example, oral instructions may be invoked to instruct, in a synchronous manner, a skill learner orally while the skill learner is following the visual instructions provided. Such oral instructions may be synchronized with the visual instructions whenever appropriate. For instance, in learning how to operate an equipment, the visual instructions may visually show a skill learner how to physically operate the equipment and oral instructions may be synchronously provided to deliver other relevant instructions (e.g., hold down the button for no longer than 10 seconds). In some situations (e.g., piano playing skill learning), any oral instructions may be invoked only when certain conditions are met, e.g., the tutoring speed is set below a certain threshold (otherwise there may not be possible to playback the oral instruction).

As discussed herein, a camera is deployed in the AI based skill learning system so that a dynamic learning environment may be observed which may then be used for the AI based skill learning system to determine how adaptively and appropriately project visual instructions (e.g., where to project the virtual fingers onto the dynamically observed piano keyboard). Such a camera may be positioned to have a proper field of view. In some embodiments, the AI based skill learning system may be embedded in a wearable that can be put on the forehead of the skill learner (see FIG. 2A). In this case, the camera deployed therein may have a consistent field of view as the skill learner.

In some embodiments, the AI based skill learning system may correspond to an application running on a smart device such as a smart phone. In this situation, the AI based skill learning system on the smart device may interface with the camera native on the device to collect data about the dynamic scene. FIG. 2B depicts an exemplary setting for AI based skill learning using a smart device to facilitate learning piano playing skills, in accordance with a different embodiment of the present teaching. In this setting, a skill learner 205 is learning piano playing on piano 260 using the AI based skill learning system deployed on a separate device 240 such as a smart phone. The smart device 240 includes a camera 240-1 and is placed in a way to have a field of view 270 encompassing the area where the hands of skill learner 205 appears as well as the keys of the piano 260. Such observation of the hands and the keys is to be used for the AI based skill learning system running on device 240 to determine how to deliver visual instructions (which may include virtual hands) by projecting virtual objects on the keys in accordance with the music 200 being played.

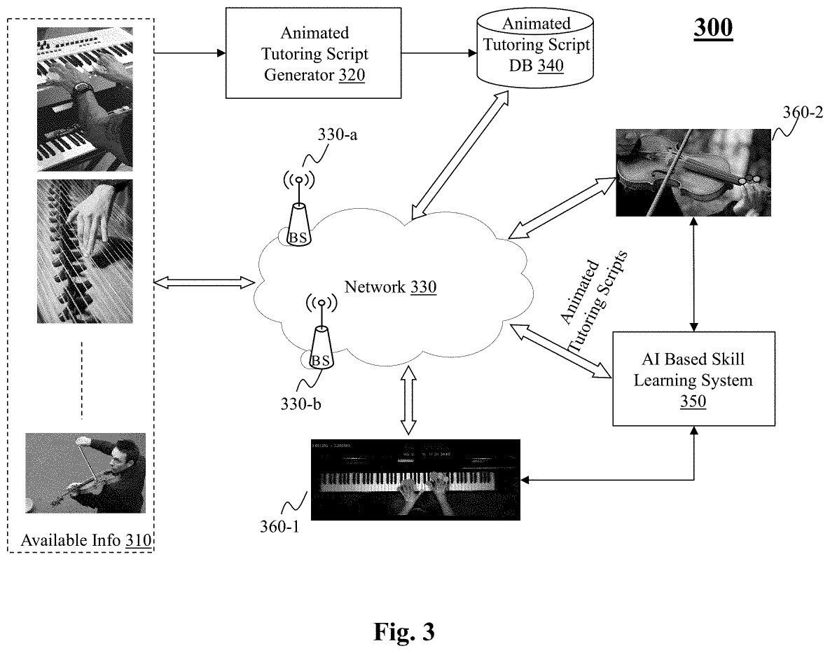

FIG. 3 depicts an exemplary networked environment 300 in which information available from different sources is used to generate animated tutoring scripts for skill learning, in accordance with an embodiment of the present teaching. In this environment, there is information 310 available from different sources, based on which, an animated tutoring script generator 320 is configured to access such available information and generate animated tutoring scripts that can then be stored in an animated tutoring script database 340. Such generated animated tutoring scripts may be used, by an AI based skill learning system 350, to conduct a skill learning session to teach a skill learner 360 to master the underlying skill. In some embodiments, the animated tutoring script generator 320 and the AI based skill learning system 350 may reside on a same device. In some embodiments, the animated tutoring script generator 320 and AI based skill learning system 350 are separately operating and may be deployed and operating on different devices. When residing on the same device, a user of the device is able to invoke the animated tutoring script generator 320 to access some data demonstrating certain skills, analyze such data, and generate animated tutoring script that can be used by an AI based skill learning system residing on the same device to facilitate the user to learn the skill based on what was demonstrated in the data. For example, a user desiring to learn how to play a specific piano piece may interact with the animated tutoring script generator 320 to generate an animated tutoring script based on some video of a famous pianist playing the piano piece. Such generated animated tutoring script incorporates information about the piece of music, instructional information (visual or oral) on, e.g., which finger is on which key and optional annotated timing/playing information, which may be synchronized with the music.

In some embodiments, the animated tutoring script generator 320 may be running as a designated system, processing different pieces of information 310 available from one or more sources, generating corresponding animated tutoring scripts, and archiving the same in database 340. In some embodiments, the animated tutoring script generator 320 may be configured to be capable of selectively processing available information to ensure that the animated tutoring script generated therefrom is of a quality that can be adequately used for skill learning. For example, if a video available on the Internet related to a pianist's performance is recorded in such a way that it is not possible to identify fully, via video processing, which finger of which hand is on which key of a piano (e.g., view of the hands may be occluded due to the way the video is recorded), the animated tutoring script generator 320 may elect not to process the video. In such a setting, there may be a plurality of AI based skill learning systems, each of which may be deployed on a user device, capable of interacting with the user of the device to selecting needed animated tutoring script(s) related to some skills desired by the user, accessing the same from database 340, interfacing with the user and the dynamic scene surrounding the user to facilitate the user to learn the skill based on the animated tutoring script.

As shown in FIG. 3, different parties in the illustrated skill learning scheme may be connected via network 330. In some embodiments, network 330 may correspond to a single network or a combination of different networks. For example, network 330 may be a local area network (“LAN”), a wide area network (“WAN”), a public network, a proprietary network, a proprietary network, a Public Telephone Switched Network (“PSTN”), the Internet, an intranet, a Bluetooth network, a wireless network, a virtual network, and/or any combination thereof. In one embodiment, network 330 may also include various network access points. For example, environment 300 may include wired or wireless access points such as, without limitation, base stations or Internet exchange points 330-a, . . . , 330-b. Base stations 330-a and 1330-b may facilitate, for example, communications to/from user devices 360 and/or, e.g., the animated tutoring script generator 320 and the AI based skill learning system 350, with one or more other components in the networked framework 300 across different types of network.

A user 360 with a device, e.g., 360-a, may be of different types to facilitate a user operating the user device to connect to network 330 and transmit/receive signals via the AI based skill learning system 350. Such a user device may correspond to any suitable type of electronic/computing device including, but not limited to, a desktop computer, a mobile device, a device incorporated in a transportation vehicle, . . . , a mobile computer, or a stationary device/computer. A mobile device may include, but is not limited to, a mobile phone, a smart phone, a personal display device, a personal digital assistant (“PDAs”), a gaming console/device, a wearable device such as a watch, a Fitbit, a pin/broach, a headphone, etc. A transportation vehicle embedded with a device may include a car, a truck, a motorcycle, a boat, a ship, a train, or an airplane. A mobile computer may include a laptop, an Ultrabook device, a handheld device, etc. A stationary device/computer may include a television, a set top box, a smart household device (e.g., a refrigerator, a microwave, a washer or a dryer, an electronic assistant, etc.), and/or a smart accessory (e.g., a light bulb, a light switch, an electrical picture frame, etc.).

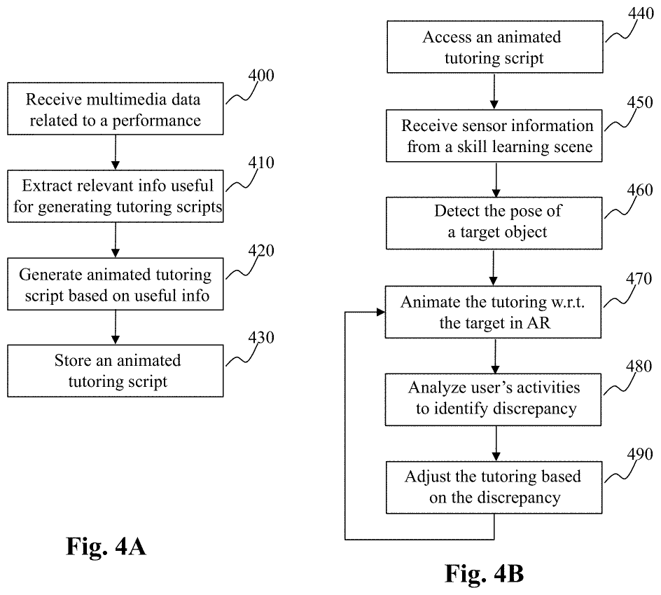

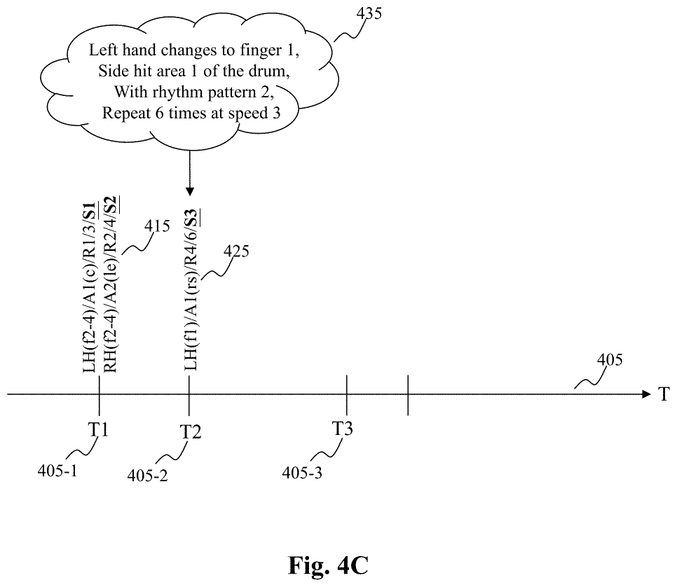

FIG. 4A is a flowchart of an exemplary high level process of creating animated tutoring scripts based on online information, in accordance with an embodiment of the present teaching. To generate an animated tutoring script, media data about a performance are first received at 400 by the animated tutoring script generator 320. Performance can be an artistic performance or a recording of some process in which a person conducted a sequence of operation, e.g., playing on drums, playing a piece of music on a musical instrument, . . . , assembling a device/equipment, operating on an equipment, etc.). In some embodiments, such received media data correspond to multimedia information with media data across different modalities such as a video which includes visual, audio, and optionally text information.

Based on such received media data, the animated tutoring script generator 320 may analyze the data in each modality to extract, at 410, relevant features in each modality that are useful for creating an animated tutoring script that can be used to teach a person the underlying skill demonstrated in the video. For example, the extracted relevant information from a video recording of a violin performance may include, e.g., the positions of different fingers with respect to different violin strings, distance among different fingers at each moments corresponding to synchronized music notes, specific pose related features of different fingers, and the associated timing information (e.g., each finger stay on a position of a string for how long, etc.). Each of such extracted features may have associated meta information such as the timing, which may be used to synchronized with certain features of another modality. For instance, features of fingers may be associated with features (such as timing) of the corresponding audio track. With extracted features of information in different modalities, the animated tutoring script generator 320 generates, at 420, an animated tutoring script and stores it, at 430, in the animated tutoring script database 340.

FIG. 4C illustrates an exemplary representation of a part of an animated tutoring script generated based on media data, in accordance with an embodiment of the present teaching. In this example, the illustrated animated tutoring script is created from, e.g., a video of a drum player. In this representation, the script may be generated along a timeline T (405) with different points of time, e.g., T1 (405-1), T2 (405-2), . . . , T3 (405-3), . . . Each point of time may be determined based on the performance of the drum player and is associated with specific skill learning instructions, which may include animated portion and/or oral portion. For example, significant points of time may be identified whenever the player changes the playing pattern so that new instructions may be generated for each such point of time. As illustrated, at each point of time, a certain script is created based on the performance pattern associated with that time. For instance, at point of time T1 (405-1), the following is observed: the player used fingers 2-4 (f2-4) of his left hand (LH) to hit the center (c) of area 1 (A1) of the drum with rhythm 1 (R1) and the pattern was repeated three times (3) at speed 1 (S1); the player also used fingers 2-4 (f2-4) of his right hand (RH) to hit the left edge portion (le) of area 2 (A2) of the drum with rhythm 4 (R4) and the pattern was repeated 6 (6) times at speed 2 (S2). Based on that observation, the animated tutoring script generator 320 may generate corresponding script summarize what happened to each hand. For example, the script at point of time T1 for the left hand may be LH(f2-4)/A1(c)/R1/3/S1 and the script at point T1 for the right hand may be RH(f2-4)/A2(le)/R2/4/S2, respectively. Similarly, the script at point T2 (405-2) derived based on observation may be coded as LH(f1)/A1(rs)/R4/6/S3, representing using finger 1 (f1) of left hand (LH) to hit the right side (rs) of area 1 (A1) with rhythm 4 (R4) with a repetition of 6 times (6) at a speed 2 (S2).

Such coded script may be created by analyzing the information from a, e.g., video recording the player. To do so, both visual and audio analytics may be applied. On the visual aspect, visual information is analyzed to capture the instrument (the drum), the general dispositions between the instrument and the player's hands, hand movements of the player with respect to the drum, finger positions relative to the known regions of the drum, relative spatial relationships among fingers. The sounds produced by the drum and synchronized with the visual information may also be analyzed to recognize different sound patterns produced due to hand movements, segment each repetition of each sound pattern that corresponds to certain type of hand movement with certain finger configurations, the temple of playing each sound pattern, etc. Each repetition of a sound pattern may then be associated with a set of hand movements that is responsible for producing the sound pattern.

The analytics of visual and audio information may then be synchronized with respect to each coherent segment based on which a consistent tutoring script may be generated. For example, segment T1-T2 is a coherent segment because one consistently repeated sound pattern produced by one set of consistently repeated hand/finger movements are observed. Given that, a coherent tutoring script for time frame T1-T2 may be created based on observed hand/finger movement with synchronized sound pattern. Similarly, T2-T3 may be another coherent segment with a different configuration of hands/fingers, different movements to produce different sound pattern/rhythm, based on which a different part of the tutoring script may be generated. Given that, a tutoring script for a drum play comprises different pieces of tutoring script each with specific tutoring instructions which may guide a skill learner to produce a sound pattern similar to what is recorded in the video.

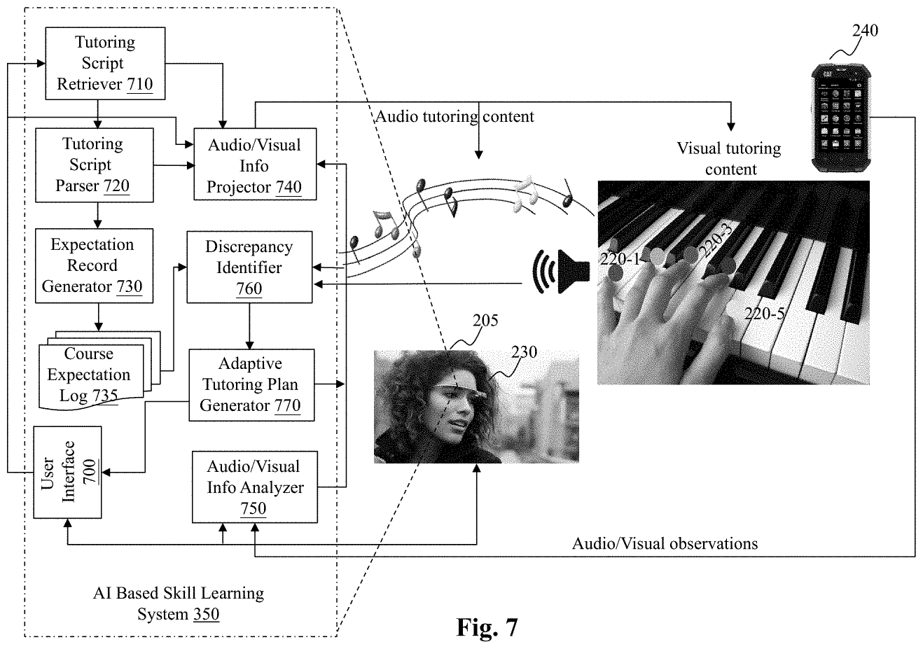

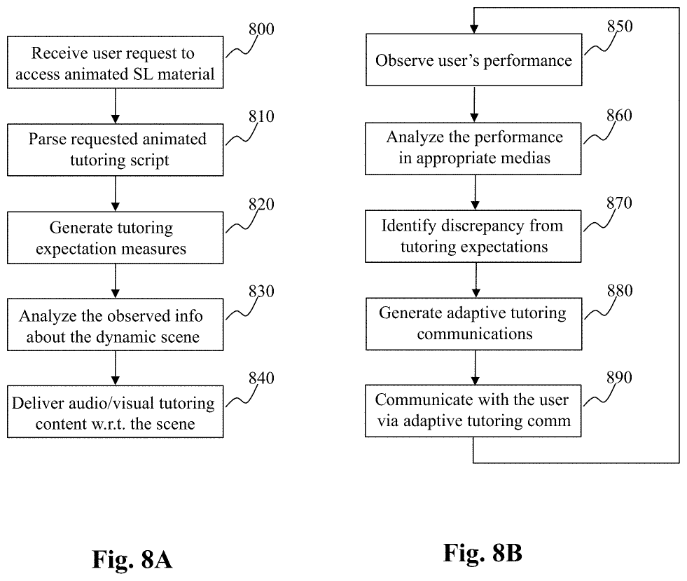

The tutoring scripts are to be generated in a manner that can be used to facilitate animated tutoring for skill learning via augment reality. That is, a script is so generated that it includes adequate information to generate an animated effect in an augment reality created by visualizing, e.g., hand/finger movements on an actual drum observed in a dynamic scene. This is via projecting virtual hands/movements on the observed actual drum based on the tutoring scripts. For example, a tutoring script as discussed herein may be used by the AI based skill learning system 350 to provide visual tutoring instructions to a skill learner. For instance, given a script LH(f1)/A1(rs)/R4/6/S3, the AI based skill learning system 350 can create an augmented reality by projecting visual hands/fingers on a drum observed in a dynamic skill learning scene to show a skill learner where to put hands with which fingers in which area of the drum and how to hit the drum with what pattern, with what speed and repetition. More details on how to generate animation to create an augmented reality to facilitate skill learning are discussed with reference to FIGS. 7-8B.

FIG. 4B is a flowchart of an exemplary process of AI based skill learning in a dynamic scene using an animated tutoring script, in accordance with an embodiment of the present teaching. When it is communicated which tutoring script is to be used to conduct skill learning, the animated tutoring script is accessed, at 440, from, e.g., the animated tutoring script database 340. To facilitate animation in an actual scene, sensor data from the skill learning scene are acquired, at 450, and analyzed to detect, at 460, a pose of the target object which is the aim of the skill learning. For example, the target object may be a piano in piano playing skill learning, a drum in learning skills of play a drum, a device in learning skills of how to operate the device, or an equipment in learning skills of testing the equipment.

With the target object detected in a dynamic scene, the AI based skill learning system 350 animates, at 470, a skill learning session . For example, the tutoring script may be used to project virtual objects (e.g., hands, fingers, movements, etc.) onto the target object detected, the oral instruction synchronized with the animated instructions may also be played back to a skill learner simultaneously. Such created augmented reality learning experience may improve the intuition of the skill learner which enhance the learning experience and effectiveness. In addition, the AI based skill learning system 350 may continue to monitor the performance of the skill learner by analyzing, at 480, the activities of the skill learner (e.g., in both visual and acoustic domain), compared with the animated tutoring script to identify discrepancies. Such detected discrepancies may then be used to adjust, at 490, the tutoring session to achieve adaptive skill learning. For example, if the initial speed of playing a drum in a skill learning session follows the speed exhibited in the initial recording (from which the animated tutoring script is derived) but it is observed that the skill learner does not appear to be able to keep up. The speed of the playback may be adjusted to a slower speed to accommodate the need of individual skill learners. Other types of needs of a skill learner may also be detected by analyzing the performance of the skill learner. For instance, a skill learner may repeatedly exhibit difficulty in, e.g., playing a drum with a particular pattern in a certain rhythm, in this case, the AI based skill learning system 350 may adaptively adjust the tutoring process by adding specific sessions targeting at a particularly sub-skills determined based on each individual skill learners. In this way, the skill learning process may repeat steps 470, 480, and 490 based on the observation of the skill learner.

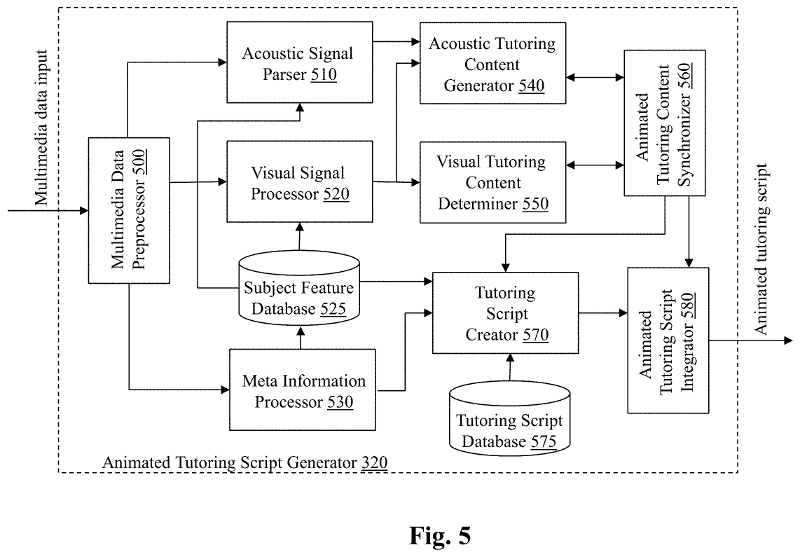

FIG. 5 depicts an exemplary high level system diagram of the animated tutoring script generator 320, in accordance with an embodiment of the present teaching. As discussed herein, in order to generate an animated tutoring script based on media data, such as a video recording a performance of a player, the animated tutoring script generator 320 is configured capable of processing data in different modalities, identifying features in each modality that are relevant to the underlying skill exhibited in the media data, and integrating features from multiple modalities to create tutoring instructions. In the embodiment illustrated in FIG. 5, the animated tutoring script generator 320 comprises a multimedia data preprocessor 500, an acoustic signal parser 510, a visual signal processor 520, a meta information processor 530, an acoustic tutoring content generator 540, a visual tutoring content determiner 550, an animated tutoring content synchronizer 560, and an animated tutoring script integrator 580. These functional components operate together to generate an animated tutoring script as output based on a multimedia data input.

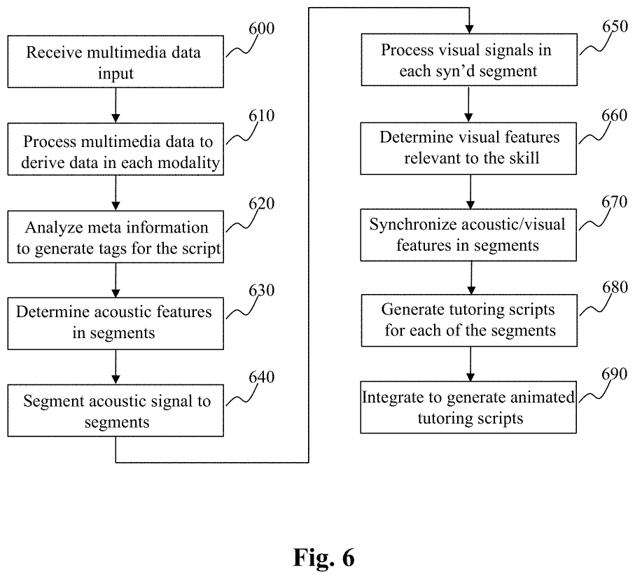

FIG. 6 is a flowchart of an exemplary process of the animated tutoring script generator 320, in accordance with an embodiment of the present teaching. In operation, multimedia input data is received, at 600 by the multimedia data preprocessor 500, and then processed, at 610, to obtain data in each of the modalities. Exemplary multimedia data input include video recording an operation conducted by a skilled person, e.g., an instrument performance by a musician, a demonstrative manipulation of a machine by a skilled technician, etc. Exemplary modalities in such multimedia data include visual (motion pictures), audio (acoustic recording), and text (captions or simply meta information). For instance, if the input is a recorded video of a piano performance, the involved media include visual recording of the performance, the audio recording of the music played, and possibly some captions and/or some meta information on, e.g., who is the player, the piece of music being played, background information of the music such as the composer of the music, period of the time, etc., a level of skill of the player, a level of proficiency needed to learn skill from the recording, etc. The meta information indicative of the proficiency required of a skill learner to benefit from the recording may be used to facilitate a determination on whether it is appropriate for a skill learner to use an animated tutoring script generated based on this video to learn the skill. If the level of proficiency is much higher or lower than the skill of the learner, it may not be appropriate skill learning material for the skill learner.

Data obtained in individual modalities may then be processed. Meta information associated with the multimedia data input, if exists, may be analyzed, at 620 by the meta information processor 530, to extract relevant meta information that can be used for different purposes. For instance, some meta information may be used for, e.g., generating tags for indexing the animated tutoring script to be generated. Meta information about a video recording of a music instrument performance may include the title of the music, the composer of the music, the name of the musician who performed, the skill level, etc. may be used to as tags for indexing the animated tutoring script to facilitate searches.

Audio information from the multimedia data input may also be analyzed, at 630 by the acoustic signal parser 510, e.g., to determine acoustic features corresponding to certain sound patterns/signatures, which may then be used to segregate the audio signal, at 640, into different segments, each of which may be used, by the acoustic tutoring content generator 540, to identify acoustic tutoring content (e.g., sound patterns) correspond to each segment to identify consistent sub-tutoring content. Taking the previously discussed example on drum skill learning, each segment may correspond to a portion of a video with a different sound pattern than its neighboring segments and can be used to develop a consistent script for tutoring a skill leaner to learn how to create the same sound pattern on the drum. Similarly, visual information in each segments determined in accordance with audio characteristics may be processed, at 650 by the visual signal processor 520, to determine, at 660 by the visual tutoring content determiner 550, features, associated with the player's performance and visually instructive, for generating visual instructions via augmented reality in facilitating a skill learner to learn. For instance, visual features related to finger positions, spatial configuration of different fingers, and their movements may be identified from the visual information and used to generate visual tutoring content or instructions that correlates with the synchronized sound patterns to guide a skill learner where to place his/her fingers, with what spatial configurations, and to carry out what hand/finger movements to create the sound patterns as recorded in the audio track.

What acoustic and visual features to be extracted may be dictated by the nature of the data. For instance, if the received multimedia data input is a video recording of piano performance by a musician, the acoustic signal parser 510 and the visual signal processor 520 may rely on information retrieved from a tutoring subject database 525 to determine what characteristics are relevant to the data. In the case of piano playing, the information to be retrieved may be directed to a piano performance recording and the specific retrieved information may dictate that finger positions relative to piano keys are relevant, features of positions of each finger may be important, etc. Extraction of skill learning related information may then be carried out in a guided manner.

In some embodiments, the audio information may be used to segment the data stream into different segments which are then used to extract corresponding features in the visual data. In some embodiments, the visual information may be used to segment the recording into different segments and then audio characteristics in each segment may be accordingly identified and correlated. In some embodiments, segmentation may be performed based on information from both audio and visual modalities. With the separately generated segments with sound patterns and skill learning relevant visual features, the animated tutoring content synchronizer 560 may then integrate the acoustic and visual features in corresponding segments at 670. Based on each of the synchronized audio/visual segments, the tutoring script creator 570 may then generate, at 680, a tutoring sub-script for each of such segments based on, e.g., the information from the tutoring subject database 525 (which may instruct what type of tutoring content to be created for which types of skills) and information from a tutoring script database 575 (which may provide script templates with content to be filled in based on what is observed in audio/visual modalities). Sub-scripts generated for different segments may then be used, by the animated tutoring script integrator 580, for integration at 690, in order to generate an animated tutoring script for the received multimedia data input.

As depicted in FIG. 3, such generated animated tutoring scripts may then be archived in an animated tutoring script database 240 with, e.g., appropriate indexing using the meta information associated with each script. Such archived animated tutoring scripts are accessible, by any user via, e.g., the AI based skill learning system 350 via network connections for skill learning purposes. To facilitate appropriate usage of archived animated tutoring scripts, the animated tutoring script database 240 may be associated with an access control mechanism (not shown) that allows a skill learner to search appropriate animated tutoring scripts based on different criteria, e.g., the skill to be learned, a level of proficiency of the learner needed, the name of the person from whom the skill learner prefers to learn the skill, the content preferred for skill learning (e.g., the person desired may have different performances and a skill learner may prefer a specific performance involving specific content), etc. The mechanism may support query by cross indexing, etc. When an appropriate animated tutoring script is identified, the script is retrieved and sent to an AI based skill learning system 350 running on a device of the skill learner.

FIG. 7 depicts an exemplary high level system diagram of the AI based skill learning system 350, in accordance with an embodiment of the present teaching. As discussed with references to FIGS. 2A-2B, a skill learner may use a device having the AI based skill learning system 350 running thereon to access an animated tutoring script and conduct a skill learning session in a dynamic scene observed surrounding the skill learner in an adaptive manner based on the accessed animated tutoring script. The device used to facilitate the skill learning session may be a wearable such as 230 shown in FIG. 2A and FIG. 7 or a handheld device such as a smart phone 250 as shown in FIG. 2B and FIG. 7. The AI based skill learning system 350 may be deployed on the device to facilitate communications with a skill learner and carry out skill learning sessions based on animated tutoring scripts. Such a device may include sensors for observing the dynamic scene surrounding the skill learner in order for the AI skill learning system 350 to appropriately project visual instructions in a real scene as well as the performance of the skill learner in order to detect discrepancy between what is expected (by the tutoring script) and the actual learning performance of the skill learner. Such a device may also include acoustic sensors to allow the AI based skill learning system 350 to utilize such sensors to obtain the acoustic recording of the performance of the skill learner in order to assess the overall discrepancy. Such detected discrepancy may be analyzed and utilized to adaptively adjust the tutoring.

FIG. 7 shows a setting in which a user 205 wearing a wearable device 230 with the AI based skill learning system 350 deployed and executing thereon that facilitates a process of learning piano playing skill. In an alternative setting, the user 205 may also use a device 240 (instead of a wearable 230) with the AI based skill learning system deployed and executed thereon to facilitate skill learning, as depicted in FIG. 2B. In either setting, a visual sensor in the wearable 230/device 240 observes the surrounding of the user 205, especially in the area where the hands are on the piano, to provide the needed information for the AI based skill learning system 350 to properly project visual instructions (e.g., 220-1, . . . , 220-3, . . . , 220-5) on the correct piano keys. The colors may be coded to be associated with their corresponding fingers. When the user 205 places fingers as visually instructed, the visual sensor may also observe the positions, spatial configurations, and the movements of the fingers and provide such information back to the AI based skill learning system 350. At the same time, the wearable 230 or the device 240 may also deploy their audio sensors to record the music resulted from the finger movements of the user. Such real-time recorded music from the skill learner may then be used to compare with the music expected based on the animated tutoring script to detect discrepancy. Such discrepancy may then be used to adaptively adjust the tutoring process.

To achieve the above functionalities, the AI based skill learning system 350 is configured to include two parts, one for providing skill learning instructions to a user based on a requested animated tutoring script and the other part for determining discrepancy in operation for the purpose of adaptively adjusting the tutoring process based on real time feedback. The first part comprises a user interface 700, a tutoring script retriever 710, a tutoring script parser 720, an expectation record generator 730, an audio/visual information analyzer 750, an audio/visual information projector 740. The user interface 700 is configured to interact with user 205 in terms of which animated tutoring script is to be selected for what type of skill learning and at what level. The communication may also include preferred content, e.g., a user at mid-level of piano playing may specify to further enhance the skill but prefer to use tutoring scripts derived based on, e.g., Bach's music and played by certain specified pianists. Once the criteria of the desired script are specified, they are sent to the tutoring script retriever 710, which may then search and identify appropriate animated tutoring scripts that satisfy what is specified by the skill leaner 205.

When a desired animated tutoring script is retrieved by the tutoring script retriever 710 from, e.g., the animated tutoring script database 340, the retrieved script is processed to render animated tutoring information to the skill learner to follow. The script may be first parsed by the tutoring script parser 720, e.g., to generate separate audio and visual instructions. To properly render the visual instructions in an augmented reality scenario, the audio/visual information analyzer 750 may receive visual information from visual sensors in the wearable/device, analyze the visual information to recognize the relevant objects (e.g., keys on a piano) in order to project finger information onto the observed objects. This is shown in FIG. 7 as colored dots on different keys, where each color may represent a specific finger. The analyzed visual information, e.g., the coordinates of different piano keys, may be transmitted from the audio/visual information analyzer 750 to the audio/visual information projector 740, which may then render visual instructions on the appropriately detected objects. The skill learner may then follow such visual instructions by placing fingers on positions indicated.

The audio/visual information included in the script may be analyzed to identify useful information that may define the expectations of the skill learner. This may be achieved by the expectation record generator 730 and such identified expectations, with respect to, e.g., both visual and audio performance, may be stored in a course expectation log 735. Such stored information may also include some adjustable parameters, e.g., the speed of tutoring, e.g., how fast the AI based skill learning system 350 will dictate the skill learner to move their fingers or play synchronized with the corresponding sound effect. A skill learner may also control the speed by specifying the parameters when interfacing with the AI based skill learning system 350 via the user interface 700. The specified speed may be communicated to the audio/visual information projector 740, that may then create the augmented reality scene with projected visual instructions in accordance with the tutoring parameters (speed) onto the piano.

Similarly, the audio information in the script, e.g., how the music should sound like and at what speed, may also be processed and each sub-section of music may be synchronized with certain visual activities or instructions. In some embodiments, the synchronized audio may not be played back to the skill learner which may help the leaner to focus on the play. In some embodiments, the audio may be played back to the learner to assist. In some embodiments, the AI base d skill learning system 350 may set default or receive specification from the skill learner on at what volume level to playback the audio track. In some embodiments, in addition to the synchronized audio associated with the music, there may be additional audio instructions, e.g., oral instruction guiding what the skill learner should do. With various parameters specified, the audio/visual information projector 740 delivers the visual tutoring content and/or audio tutoring content to the skill learner 205.

Once the tutoring session is initiated based on the parsed animated tutoring script, the AI based skill learning system 350 may continue the tutoring session based on on-the-fly observations made via sensors to achieve adaptive tutoring. To achieve that, the second part of the AI based skill learning system 350 comprises the audio/visual information analyzer 750, a discrepancy identifier 760, and an adaptive tutoring plan generator 770. The audio/visual information analyzer 750 receives on-the-fly observations from sensors located in the wearable 230/device 240 and analyze the received signals. The analysis may be directed to the performance features such as the hand positions and movements, and/or the sound yielded from the play of the skill learner. The analyzed signals may then be sent to the discrepancy identifier 760, that may compare the performance features extracted from the observations with what is the expected performance features specified in the expectation log 735. Such identified discrepancies may then be used as the basis for the adaptive tutoring plan generator 770 to derive a revised tutoring plan that may be considered as appropriate based on the observations. For example, if it is consistently observed that the skill learner's hand positions deviate too much from what were instructed, the adaptive tutoring plan generator 770 may adjust the plan to stop the continuous playing and focus on more static teaching of hand positions. If the skill leaner's playing speed is consistently lagging behind the expected speed, the adaptive tutoring plan generator 770 may adjust the required speed of the hand movements to slow down until the skill learner becomes familiar with the piece. In some embodiments, based on the observations, the adaptive tutoring plan generator 770 may also generate oral communication content that summarize the issues (e.g., the sound of a certain finger is always too weak, the hands are too far away from the black keys so that the sounds coming from such playing is not loud enough, fingers need to be arched more to produce music notes with more clarity) observed and remind the skill learner to pay attention to the identified issues.

As discussed herein, the AI based skill learning system 350 performs its functionalities directed to two parts. The first part is to deliver animated skill learning tutoring instructions based on an animated tutoring script. FIG. 8A is a flowchart of an exemplary process of delivering animated skill learning tutoring instructions based on an animated tutoring script via the AI based skill learning system, in accordance with an embodiment of the present teaching. At 800, the user interface 700 interacts with a skill learner 205 to receive a request to access a certain animated skill learning materials. Upon retrieving the requested animated tutoring materials from, e.g., the animated tutoring script database 340, the tutoring script parser 720 parses, at 810, the retrieved animated tutoring script. Based on the parsed animated tutoring script, the expectation record generator 730 may establish, at 820, the expected performance for this skill learning and stores such established expected performance information in the course expectation log 735. The expectation established depends on the skill to be acquired. For example, if the skill acquired is related to some audible performance such as drum, violin, or piano, then the audio may be the basis for the assessment which may also be done in conjunction with an assessment of the hand positions, movements, strength, etc. For some skills, there may be no expectation established. For instance, a skill learner may want to learn how to connect an electronic device with other equipment in the household. In this case, the skill learner may acquire that skill by following the visual/audio instructions devised from an animated tutoring script without needing to necessarily meet certain performance expectations. How to set up the expected performance may be specified in the script.

Once the script is parsed, in order to deliver the animated tutoring materials (e.g., visual and/or audio) to the skill learner in a manner that is consistent with the dynamic scene observed, the audio/visual information analyzer 750 analyzes, at 830, the information observed via sensors related to the dynamic scene surrounding the skill learner. Such analyzed information may then be used, by the audio/visual information projector 740 at 840, to deliver the audio/visual tutoring content to the dynamically observed scene. For example, if the skill learning is directed to piano playing skill, in order to project visual instructions (e.g., which fingers are which keys) on the piano the skill learner is using to play, the AI based skill learning system 350 needs to know the pose of the skill learner's piano. In some embodiments, the manner by which audio/visual instructions are to be delivered may be parameterized, e.g., the speed at which the AI based skill learning system 350 is to direct the skill learner to play.

The second part of the AI based skill learning system 350 is to adapt the animated skill learning tutoring based on an adaptively modified tutoring plan devised based on actually observed real-time learning performance of the skill learner. FIG. 8B is a flowchart of an exemplary process of the second aspect of the AI based skill learning system for adaptively tutoring a skill based on an animated tutoring script and dynamic observations, in accordance with an embodiment of the present teaching. Once the animated tutoring instructions are provided or delivered to create an augmented reality scene (see FIGS. 2A and 7), sensors on the wearable 230 or the device 240 are utilized to make observations, at 850, of the skill learner's performance. Such observed information is sent to the audio/visual information analyzer 750 which then analyzes, at 860, the skill learner's performance in terms of following the animated tutoring instructions. The analysis on observations in each modality (e.g., audio or video) may be performed individually or jointly. The analysis may yield various measures in different modalities. For example, hand positions with respect to observed keys on a piano, spatial configurations among different fingers, movements of the fingers, etc. Acoustically, the analysis may yield different measurements such as the rhythms, sound patterns, etc. resulted from the skill learner's performance.

Such measurements from the dynamic observations may be further processed to identify, at 870, discrepancies between expected performance and the skill learner's actual performance. This is achieved by the discrepancy identifier 760. For example, visually it may be analyzed whether the skill learner's hands/fingers were positioned as shown in the augmented reality scene, whether the skill learner's hands/fingers moved in accordance with the visual/audio instructions. In addition, acoustically, audio information observed may also be analyzed in light of the expected sound effect as expected to obtain discrepancy in the audio domain. Based on the discrepancies, the adaptive tutoring plan generator 770 may generate accordingly, at 880, an adaptive tutoring plan with respect to the discrepancies. In some embodiments, such modification may be adapted based on the playing speed. In some embodiments, the adjustment to the tutoring plan may be to return to some more teaching content to be delivered to the skill learner. In some embodiments, the modification may also be personalized based on the learning history of the current skill learner. With the adaptively modified tutoring plan, the user interface 700 may communicate, at 890, with the skill learner using the adapted tutoring plan, which may include informing the skill learner the adjustment to the tutoring content before proceeding to carrying out the adjust tutoring plan via the audio/visual information projector 740 to deliver the modified tutoring content to the skill learner.

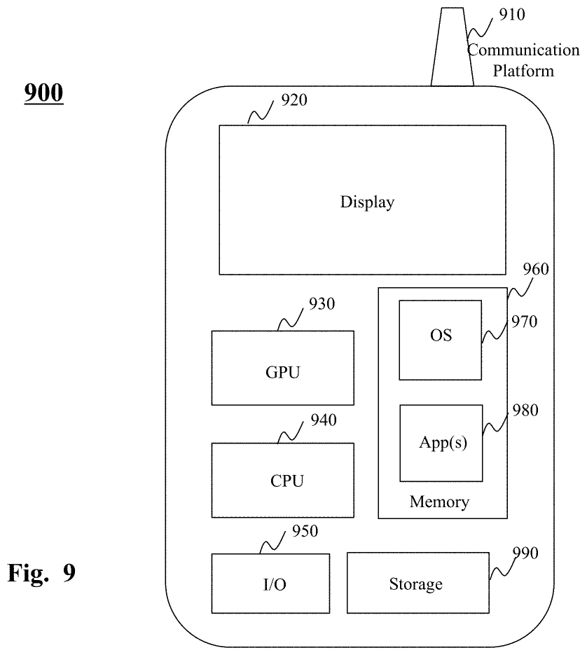

FIG. 9 is an illustrative diagram of an exemplary mobile device architecture that may be used to realize a specialized system implementing the present teaching in accordance with various embodiments. In this example, a device on which the present teaching is implemented corresponds to a mobile device 900, including, but is not limited to, a smart phone, a tablet, a music player, a handled gaming console, a global positioning system (GPS) receiver, and a wearable computing device (e.g., eyeglasses, wrist watch, etc.), or in any other form factor. Mobile device 900 may include one or more central processing units (“CPUs”) 940, one or more graphic processing units (“GPUs”) 930, a display 920, a memory 960, a communication platform 910, such as a wireless communication module, storage 990, and one or more input/output (I/O) devices 940. Any other suitable component, including but not limited to a system bus or a controller (not shown), may also be included in the mobile device 900. As shown in FIG. 9 a mobile operating system 970 (e.g., iOS, Android, Windows Phone, etc.), and one or more applications 980 may be loaded into memory 960 from storage 990 in order to be executed by the CPU 940. The applications 980 may include a browser or any other suitable mobile apps for managing a conversation system on mobile device 900. User interactions may be achieved via the I/O devices 940 and provided to the automated dialogue companion via network(s) 120.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming and general operation of such computer equipment and as a result the drawings should be self-explanatory.

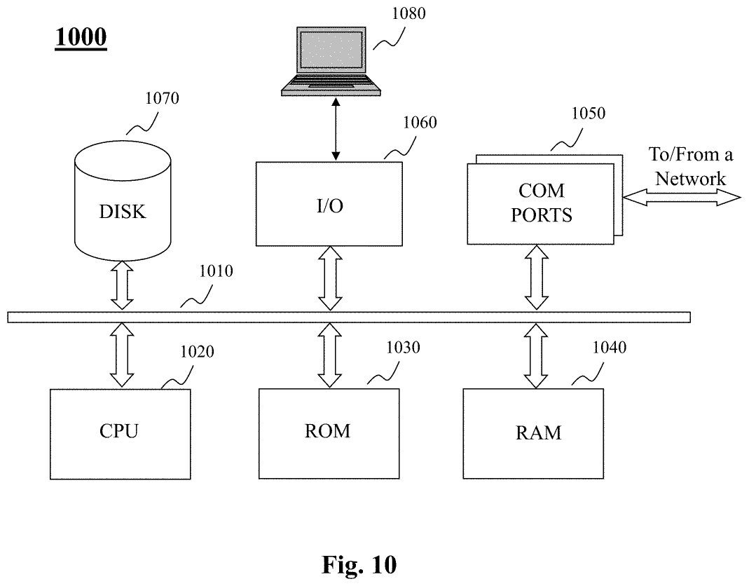

FIG. 10 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general purpose computer or a special purpose computer. Both can be used to implement a specialized system for the present teaching. This computer 1000 may be used to implement any component of conversation or dialogue management system, as described herein. For example, conversation management system may be implemented on a computer such as computer 1000, via its hardware, software program, firmware, or a combination thereof. Although only one such computer is shown, for convenience, the computer functions relating to the conversation management system as described herein may be implemented in a distributed fashion on a number of similar platforms, to distribute the processing load.

Computer 1000, for example, includes COM ports 1050 connected to and from a network connected thereto to facilitate data communications. Computer 1000 also includes a central processing unit (CPU) 1020, in the form of one or more processors, for executing program instructions. The exemplary computer platform includes an internal communication bus 1010, program storage and data storage of different forms (e.g., disk 1070, read only memory (ROM) 1030, or random access memory (RAM) 1040), for various data files to be processed and/or communicated by computer 1000, as well as possibly program instructions to be executed by CPU 1020. Computer 1000 also includes an I/O component 1060, supporting input/output flows between the computer and other components therein such as user interface elements 1080. Computer 1000 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with conversation management. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution˜e.g., an installation on an existing server. In addition, the fraudulent network detection techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine including at least one processor, memory, and communication platform capable of connecting to a network for facilitating skill learning, the method comprising:
receiving multimedia data in different modalities recorded based on a performance exhibiting a skill;
analyzing data in each of the modalities to extract information relevant to the skill exhibited in the performance;
generating an animated tutoring script based on the information in each of the modalities relevant to the skill; and
archiving the animated tutoring script for future access to enable a skill learning session in an augmented reality.

2. The method of claim 1, wherein the multimedia data correspond to a video with information in a plurality of modalities including visual, audio, and optionally text.

3. The method of claim 1, wherein the skill includes playing a musical instrument, operating on a machinery, and/or assembling a device.

4. The method of claim 1, wherein the animated tutoring script includes at least one of an animated visual instruction used to render a dynamic scene to create augmented reality, an audio instruction for oral tutoring, and meta information.

5. The method of claim 4, wherein the meta information includes at least one of information related to the performance, a first indication of a level of proficiency of the performance, and a second indication of a level of proficiency required for a skill learner to possess in order to be able to enhance the skill based on the animated tutoring script.

6. The method of claim 1, further comprising:
receiving a request to access the animated tutoring script from a skill learner who desires to improve the skill;
analyzing information included in the request about surrounding of the skill learner;
parsing the animated tutoring script to obtain audio/visual tutoring instructions; and
delivering the audio/visual tutoring instructions appropriate to the surrounding of the skill learner.

7. A system for facilitating skill learning, comprising:
a multimedia data preprocessor configured for
receiving multimedia data in different modalities recorded based on a performance exhibiting a skill, and
analyzing data in each of the modalities to extract information relevant to the skill exhibited in the performance; and
an animated tutoring script integrator configured for
integrating a tutoring script generated based on the skill and multimedia features synchronized with the tutoring script in each of the modalities relevant to the skill to generate an animated tutoring script, and
archiving the animated tutoring script for future access to enable a skill learning session in an augmented reality.

8. The systems of claim 7, wherein the multimedia data correspond to a video with information in a plurality of modalities including visual, audio, and optionally text.

9. The system of claim 7, wherein the skill includes playing a musical instrument, operating on a machinery, and/or assembling a device.

10. The system of claim 7, wherein the animated tutoring script includes at least one of an animated visual instruction used to render a dynamic scene to create augmented reality, an audio instruction for oral tutoring, and meta information.

11. The system of claim 10, wherein the meta information includes at least one of information related to the performance, a first indication of a level of proficiency of the performance, and a second indication of a level of proficiency required for a skill learner to possess in order to be able to enhance the skill based on the animated tutoring script.

12. The system of claim 1, further comprising:
an audio tutoring content generator configured for segmenting an acoustic signal in the multimedia data into segments based on acoustic features of the acoustic signal;
a visual tutoring content determiner configured for determining visual features of a visual signal corresponding to the segments of the multimedia data;
an animated tutoring content synchronizer configured for synchronizing the acoustic features and the visual features according to the segments; and
a tutoring script generator configured for generating tutoring script based on the skill and the segments.

13. A method implemented on at least one machine including at least one processor, memory, and communication platform capable of connecting to a network for adaptive skill learning, the method comprising:
receiving an animated tutoring script based on a request of a skill learner to learn a skill, wherein the animated tutoring script is generated based on multimedia data in different modalities of a performance exhibiting the skill;
analyzing surrounding of the skill learner;
creating an augmented reality based on the animated tutoring script with respect to the surrounding, wherein the skill learner is tutored in the augmented reality in accordance with the animated tutoring script;
obtaining observations of the skill learner during learning the skill in the augmented reality;
analyzing the observations to identify a discrepancy between achievement of the skill learner and the performance; and
adapting audio/visual instructions of the animated tutoring script based on the discrepancy.

14. The method of claim 13, wherein the multimedia data include a video with information in visual, audio, and optionally text modalities.

15. The method of claim 13, wherein the skill includes playing a musical instrument, operating on a machinery, and/or assembling a device.

16. The method of claim 13, wherein the animated tutoring script includes at least one of animated visual instruction to be used to create a dynamic augmented reality, audio instruction to be used for oral tutoring, and meta information.

17. The method of claim 16, wherein the meta information includes at least one of information related to the performance, a first indication of a level of proficiency of the performance, and a second indication of a level of proficiency required for a skill learner to possess in order to be able to enhance the skill based on the animated tutoring script.

18. A system for adaptive skill learning comprising:
a tutoring script retriever configured for receiving an animated tutoring script based on a request of a skill learner to learn a skill, wherein the animated tutoring script is generated based on multimedia data in different modalities of a performance exhibiting the skill;
an audio/visual information analyzer configured for analyzing surrounding of the skill learner;
an audio/visual information projector configured for creating an augmented reality based on the animated tutoring script with respect to the surrounding, wherein the skill learner is tutored in the augmented reality in accordance with the animated tutoring script;
a discrepancy identifier configured for analyzing observations of the skill learner during learning the skill in the augmented reality to identify a discrepancy between achievement of the skill learner and the performance; and
an adaptive tutoring plan generator configured for adapting audio/visual instructions of the animated tutoring script based on the discrepancy.

19. The system of claim 18, wherein the multimedia data include a video with information in visual, audio, and optionally text modalities.

20. The system of claim 18, wherein the skill includes playing a musical instrument, operating on a machinery, and/or assembling a device.

21. The system of claim 18, wherein the animated tutoring script includes at least one of animated visual instruction to be used to create a dynamic augmented reality, audio instruction to be used for oral tutoring, and meta information.

22. The system of claim 21, wherein the meta information includes at least one of information related to the performance, a first indication of a level of proficiency of the performance, and a second indication of a level of proficiency required for a skill learner to possess in order to be able to enhance the skill based on the animated tutoring script.
